(19) United States
(12) Patent Application Publication
(10) Pub. No.: US 2004/0160039 A1
(43) Pub. Date: Aug. 19, 2004

(54) Gas bag module

(75) Inventors: Helga Heist, Laufach (DE); Matthias Helmstetter, Aschaffenburg (DE); Martin Kreuzer, Kleinwallstadt (DE); Christian Lorenz, Leidersbach (DE); Michael Schneider, Sulzbach (DE); Thomas Werner, Shelby Township, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/780,386

(22) Filed: Feb. 17, 2004

(30) Foreign Application Priority Data
Feb. 18, 2003 (DE) 103 06 710.8

(51) Int. Cl. B60R 21/16

(52) U.S. Cl. 280/728.2

(57) ABSTRACT

A gas bag module comprises a ring-shaped gas bag (3) which when inflated has a ring-shaped chamber (18) surrounding a central, non-inflated section (15), and further comprises a module covering (9). The gas bag (3) is housed in the module so as to be folded around a central spacer piece (23). The spacer piece (23) has a first end in the region of the module covering (9) and a second end facing away from the module covering (9). The spacer piece (23) is fastened to a holding piece (10) at the second end and extends laterally outwards from the second end and towards the module covering. The portion of the spacer piece (23) which extends laterally outwards from the second end and towards the module covering (9) includes a curved outer surface (26), as seen in a section taken in the direction from the holding piece (10) to the module covering (9).

### TECHNICAL FIELD

The invention relates to a gas bag module.

### BACKGROUND OF THE INVENTION

Known gas bag modules typically comprise a ring-shaped gas bag which when inflated has a ring-shaped chamber surrounding a central, non-inflated section. Gas bag modules of this type commonly include a module covering, the gas bag being housed in the module so as to be folded around a central spacer piece. The spacer piece has a first end in the region of the module covering and a second end facing away from the module covering, the spacer piece being fastened to a holding piece at the second end and extending laterally outwards from the second end and towards the module covering.

The invention relates in particular to gas bag modules in which a metal emblem is arranged externally, which has a lateral extent which reaches beyond the lateral extent of the holding piece at its end on the covering side.

The spacer piece can on the one hand have the task of holding a central section of the covering which is stationary on opening of the module, or on the other hand of co-defining the module outer surface. The background to this task is the hitherto usual fastening of metal emblems to the front side of the covering or spacer piece, which are relatively heavy and wide and have to be securely fastened to the module when the covering tears open. For this purpose, the part of the covering which carries the emblem is not swiveled outwards on tearing open of the covering, but rather remains stationary.

A generic gas bag module is known from DE 197 49 914 C2. In this gas bag module, the spacer piece is a guide sleeve which widens outwards in a funnel shape, more precisely in the shape of a truncated cone towards the end on the covering side, in order to direct the gas bag outwards on unfolding. The forces applied onto the spacer piece are, however, quite high.

The invention provides a gas bag module in which the unfolding is improved in the region of the spacer piece and the forces applied onto the spacer piece are reduced.

### BRIEF SUMMARY OF THE INVENTION

According to the invention, a gas bag module comprises a ring-shaped gas bag which when inflated has a ring-shaped chamber surrounding a central, non-inflated section, and further comprises a module covering. The gas bag is housed in the module so as to be folded around a central spacer piece. The spacer piece has a first end in the region of the module covering and a second end facing away from the module covering. The spacer piece is fastened to a holding piece at the second end and extends laterally outwards from the second end and towards the module covering. The portion of the spacer piece which extends laterally outwards from the second end and towards the module covering includes a curved outer surface, as seen in a section taken in the direction from the holding piece to the module covering. The spacer piece consequently does not have a frustum-shaped section in the section which runs obliquely outwards and projects laterally beyond the holding piece.

Whereas in prior art a frustum-shaped surface is provided, the invention provides a curved surface, i.e. in longitudinal section a surface running in a convex curve shape. It is therefore easier for the gas bag to slide along the surface.

Here, in addition, provision is made in the preferred embodiment that the curvature varies along the surface. Towards the end on the covering side, it has in fact an increasingly less inclination in the laterally outward direction, i.e. its orientation, which is determined by a tangent, approaches the axial direction which runs from the holding piece to the covering. In a steering wheel module, the axial direction usually is the direction of the steering wheel axis. Therefore the gas bag is not unfolded outwards in a funnel shape as in prior art; rather, it can move out from the module exclusively or almost predominantly in the region of its inner edge in axial direction.

Provision is made that the holding piece has a contact surface for the spacer piece and that the part of outer surface that projects laterally with respect to the contact surface runs in a curved shape. The spacer piece can therefore have a flat end face on the rear side, by which it is fastened to the holding piece. The laterally projecting part is, however, to run in a curved shape, in order to make possible an easy sliding along of the gas bag during unfolding.

Preferably, the entire surface is curved from the end face facing the holding piece up to the end face facing the covering; the curvature, as mentioned, being able to decrease towards the end on the covering side and the orientation being increasingly axial.

Furthermore, however, the end of the spacer piece on the covering side could in fact be cylindrical.

In contrast to the spacer piece according to prior art, the spacer piece is a solid body or a ribbed body, i.e. not a hollow sleeve. This allows the spacer piece to be constructed from plastic.

According to an embodiment, the holding piece is a cage surrounding the gas generator; the holding piece can also be the gas generator itself, when the cage is omitted.

### BRIEF DESCRIPTION OF THE DRAWINGS

FIG. 1 shows a longitudinal sectional view through a gas bag module according to the invention with an inflated gas bag,

FIG. 2 shows a perspective top view onto the inflated gas bag according to FIG. 1,

FIG. 3 shows a longitudinal sectional view through the gas bag module with the gas bag not unfolded, in accordance with a first embodiment,

FIG. 4 shows a longitudinal sectional view through the gas bag module of the invention according to FIG. 3, in the region of the holding piece and of the spacer piece with the gas bag unfolded and

FIGS. 5 to 7 show side views of various embodiments of the spacer piece.

### DETAILED DESCRIPTION OF THE PREFERRED EMBODIMENTS

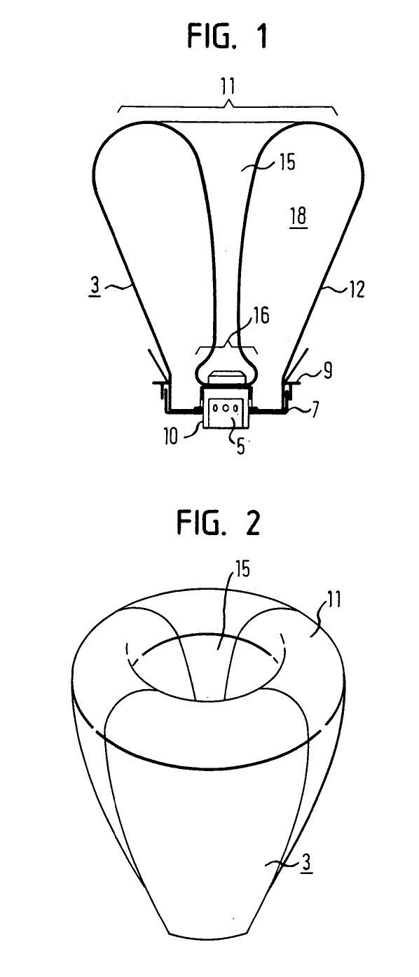

In FIG. 1 a gas bag module is illustrated, which is housed in the steering wheel or in the instrument panel. The gas bag module has a gas bag 3, a gas generator 5, a module housing 7 with a module covering 9 and a holding piece 10 surrounding the gas generator. The holding piece may, however, for example also be a bracket fastened rigidly to the module housing 7 or another part of identical function.

The gas bag 3 has several sections, namely a front wall 11 which faces the occupant in the inflated state and onto which the latter strikes in the case of restraint. Furthermore, a rear wall 12 is provided. The front wall 11 has a central deep indentation 15, which is formed in that a section of the front wall 11, hereinafter named the center section 16, is prevented from movement out from the module in the case of restraint. Thereby, in the inflated state, the gas bag is given its characteristic ring-shaped form with a ring-shaped chamber 18, which surrounds the non-inflated section, i.e. the indentation 15.

In FIG. 2 the shape of the inflated gas bag can be seen in closer detail, it being stressed that the indentation 15 can also be closed in that the gas bag sections which form the indentation contact each other at the opening of the indentation.

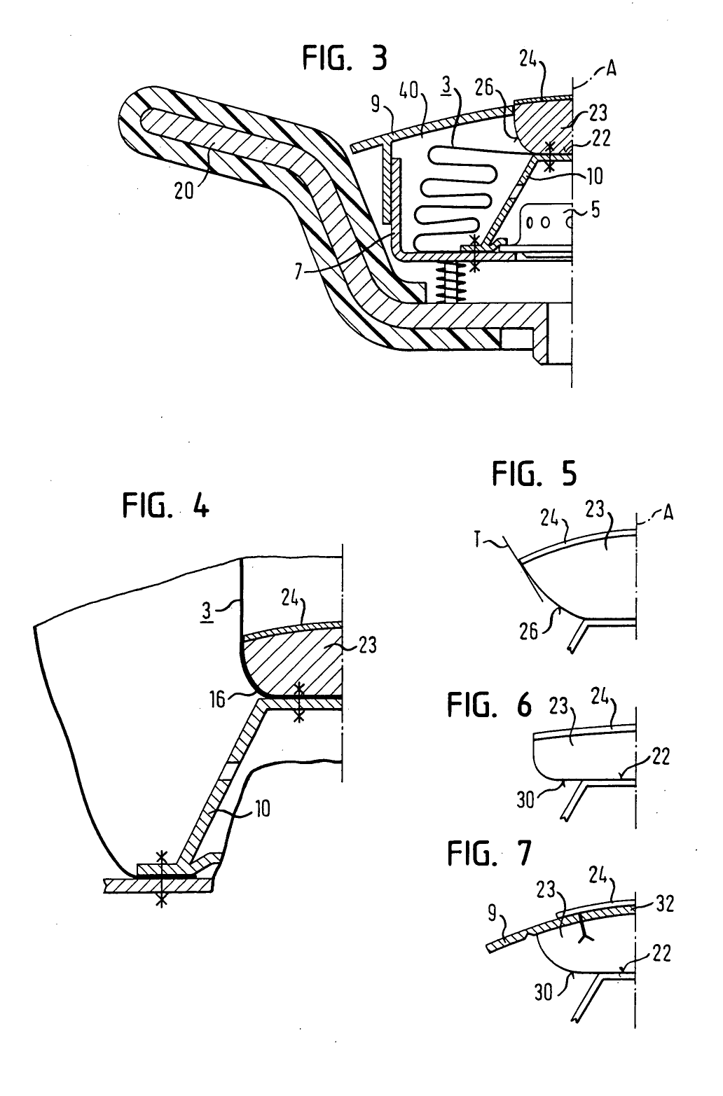

In FIG. 3 a steering wheel 20 can be readily seen with the gas bag module. The axis A of the steering wheel is, at the same time, the imaginary mid-point of the module. The holding piece 10 has a flat contact surface 22 towards the covering 9. Between the contact surface 22 and the covering 9, a spacer piece 23 extends (a solid body or a ribbed body), which is screwed to the holding piece 10. The center section 16 of the gas bag is clamped between the spacer piece 23 and the holding piece 10. The module covering 9 has a central opening, through which the spacer piece 23 extends so as to be visible from the exterior. A large metal emblem 24 is fastened on the first end face (cover side end) of the spacer piece 23.

The spacer piece 23 includes an outer surface 26 which in longitudinal section, i.e. in the section shown and as viewed from the holding piece to the covering, runs in a curved shape, to be more precise from that section of the spacer piece 23 which projects laterally with respect to the contact surface 22. The convex curvature is constructed such that starting from the holding piece 10, i.e. from the second end of the spacer piece 23, firstly a small radius, i.e. an intensive curvature is provided, which then becomes increasingly less, to finally run out in a cylindrical end on the covering side. The surface 26 is therefore inclined increasingly less laterally outwards towards the end on the covering side, in the embodiment shown in FIG. 3 even no longer inclined outwards at all at the end on the covering side, but rather runs parallel to the axis A. In the part running obliquely outwards and the same time upwards, to the side of the contact surface 22, the surface 26 is, however, curved in a convex shape.

The gas bag can move very well along the smooth and continuously curved surface during unfolding. Also, the forces exerted onto the gas bag fabric can be distinctly reduced in this region compared with prior art. The gas bag is, furthermore, stressed more uniformly in the region of the spacer piece 23.

Also the alignment of the gas bag during unfolding is almost parallel to the axis A, as regards the gas bag in the region of the indentation 13. FIG. 4 shows the unfolding gas bag 3.

FIGS. 5 to 7 are intended to show various shapes and curvatures of the spacer piece 23.

In the embodiment according to FIG. 5, the tangent T of the surface 26 towards the end on the covering side approaches a parallel to the axis A, the entire surface 26, however, running in a curved shape.

In the embodiments according to FIGS. 6 and 7, the spacer piece already projects laterally with respect to the contact surface 22 in the region of its end face 30 facing the holding piece 10, i.e. at its second end facing away from the module covering 9.

The curvatures of the surfaces 26 become less towards the end on the covering side. In the embodiment according to FIG. 6, the end on the covering side is a short cylindrical section, and in the embodiment according to FIG. 7 it is a slightly curved section.

The embodiment according to FIG. 7 also differs from the previous embodiments in that the covering 9 runs above the spacer piece 23 and is fastened thereto. The central section 32 of the covering 9, which comes to lie on the spacer piece 23, remains stationary during the tearing open of the covering 9. The covering 9 tears open to the side of the spacer piece, so that a ring-shaped outlet opening is formed.

In the non-unfolded state (FIG. 3), the gas bag 3 is housed folded around the holding piece 10 and the central spacer piece 23 in a ring-shaped chamber 40.

The invention relates in particular to gas bag modules in which a metal emblem is arranged externally, which has a lateral extent which reaches beyond the lateral extent of the holding piece at its end on the covering side.

1. A gas bag module, comprising
a ring-shaped gas bag (3), which when inflated has a ring-shaped chamber (18) surrounding a central, non-inflated section (15),
a module covering (9),
said gas bag (3) being housed in said module so as to be folded around a central spacer piece (23), said spacer piece (23) having a first end in a region of said module covering (9) and a second end facing away from said module covering (9), said spacer piece (23) being fastened to a holding piece (10) at said second end and extending laterally outwards from said second end and towards said module covering,
wherein
that portion of said spacer piece (23) which extends laterally outwards from said second end and towards said module covering (9) includes a curved outer surface (26) as seen in a section taken in a direction from said holding piece (10) to said module covering (9).

2. The gas bag module according to claim 1, characterized in that, towards said module covering, said outer surface (26) has an increasingly less inclination in a laterally outward direction.

3. The gas bag module according to claim 1, characterized in that said holding piece (10) has a contact surface (22) for said spacer piece (23) and said outer surface (26) projecting laterally with respect to said contact surface (22) runs in a convex curved shape.

4. The gas bag module according to claim 1, characterized in that said outer surface (26) as a whole runs in a curved shape, from an end face of said spacer piece (23) facing said holding piece (10) toward an end face at said first end.

5. The gas bag module according to claim 1, characterized in that said spacer piece (23) is one of a solid body and ribbed body.

6. The gas bag module according to claim 1, characterized in that said module covering (9) is fastened to said spacer piece (23).

7. The gas bag module according to claim 6, characterized in that said spacer piece (23) extends outwards through a central opening in said module covering (9).

8. The gas bag module according to claim 7, characterized in that an emblem (24) of metal is fastened to said first end of said spacer piece (23).

9. The gas bag module according to claim 1, characterized in that said module covering (9) extends over an end face of said spacer piece (23) at said first end, said module covering (9) having a central section which remains fastened to said spacer piece (23) when said module covering (9) tears open.

10. The gas bag module according to claim 1, characterized in that said holding piece (10) is a cage surrounding a gas generator (5).
